(19) United States
(12) Patent Application Publication
(10) Pub. No.: US 2011/0265010 A1
(43) Pub. Date: Oct. 27, 2011

(54) SYSTEM AND METHOD FOR GENERATION OF WEBSITE DISPLAY AND INTERFACE

(76) Inventors: David William FERGUSON, Toronto (CA); Robert TROJAN, Woodbridge (CA); Tiangui ZHENG, Concord (CA); Daniel LAM, Richmond Hill (CA)

(21) Appl. No.: 12/768,594

(22) Filed: Apr. 27, 2010

(51) Int. Cl. G06F 3/00; G06F 3/048

(52) U.S. Cl. 715/742; 715/810; 715/744

(57) ABSTRACT

Systems, methods and computer programming relating to generating website presentation of functions and content to a user is described. In an exemplary method, there are components of one or more web applications provided to a user interface application on the internet generated at a user display device. A first web application provides control of the display of information upon the user interface on the user display device based on user context information associated with a user of the user display device. There is determining a user perspective associated with the user accessing the user interface, and selecting the one or more web applications as those associated with the user perspective. There is further retrieving one or more contributions from the one or more web applications associated with the user perspective based on the user context information, and displaying the retrieved one or more contributions, and content provided by the dedicated first web application, upon the user interface at the user display device.

### FIELD

The embodiments described herein relate generally to websites, and their accompanying user interfaces, and more specifically to systems and methods for generation and integration of multiple interfaces or displays seamlessly within one or more websites.

### BACKGROUND

In developing web applications and interfaces therefor, tools are created and used to aid in the development process to improve navigation, access controls, data display and other functionalities. In order to streamline the development process, many of the controls for features are grouped together in order to be able to provide for ease of reuse for such code. However, as such functionalities are streamlined, the complexity required to track such functions and engage such functions also increases.

### SUMMARY

In an aspect of the invention, a method for generating a user interface customized for a user is provided. The method comprises (a) retrieving one or more user identifiers associated with the user, (b) selecting a predetermined user perspective based on the one or more user identifiers, (c) sending a request to the one or more web applications associated with the user perspective, each web application receiving the request responding with one or more menu contributions that are determined based on the one or more user identifiers, and (d) displaying the one or more menu contributions received from the one or more web applications upon the user interface.

The computer implemented method includes one or more user identifiers which include information regarding one or more offerings that are available to the user; perspectives which are comprised of one or more web applications and are accessed through a dedicated URL, and the determination of one or more user identifiers through use of an authentication web application which are stored in a centralized cache for retrieval by the one or more web applications for use in generating the interface.

In an aspect of the invention, a computer implemented method for generating on a display device a user interface customized for a user, the user having associated context information is provided. The method comprises the steps of; (a) selecting a first web application to control the display upon the user interface based on the context information, the first web application accessing a second web application and a third web application, (b) retrieving one or more style components from the second web application based on the user's context information, (c) retrieving one or more menu components from the third web application based on the user's context information, (d) displaying the one or more style components and one or more menu components upon the user interface on the display device.

The computer-implemented method includes one or more menu components that are retrieved based on a perspective associated with the user; determining the perspective based on context information; displaying content upon the user interface through one or more additional functional web applications, each functional web application having associated with it content; determining the functional web applications based on context information; and determining the user's interaction with the one or more menu components.

In an aspect of the invention, a computer implemented method for integrating the components of one or more web applications into a user interface being generated at a user display device is provided. The method comprises the steps of (a) determining a first web application for controlling the display of information upon the user interface on the user display device based on user context information associated with a user of the user display device, (b) determining a user perspective associated with the user accessing the user interface, (c) selecting the one or more web applications as those associated with the user perspective, (d) retrieving one or more contributions from the one or more web applications associated with the user perspective based on the user context information, and (e) displaying the retrieved one or more contributions, and content provided by the dedicated first web application, upon the user interface at the user display device.

The computer-implemented method includes; the user perspective is determined based on user context information; retrieving one or more style components from a dedicated style web application; determining the one or more style components are determined based on the user context information; accessing the web applications through dedicated URLs; determining the user context information based on an authentication web application; and storing the user context information is stored in a centralized cache.

In an aspect of the invention, a computer implemented method of controlling the display of a user interface on a display device is provided. The method comprises the steps of: (a) appointing a first web application for controlling an initial display of information upon the user interface on the user display device, based on user context information associated with a user of the user display device, (b) retrieving a first set of one or more contributions from one or more web applications associated with a user perspective based on the user context information, and displaying the retrieved first set of one or more contributions, and content provided by the first web application, upon the user interface at the user display device, (c) receiving user input based on user interaction with the first set of one or more contributions, (d) appointing a second a web application for controlling a subsequent display of information upon the user interface on the display device, based on the user interaction with the first set of one or more menu contributions, and (e) retrieving a second set of one or more contributions from the one or more web applications associated with the user interaction with the first set of one or more contributions, and displaying the retrieved second set of one or more contributions upon the user interface at the user display device.

The computer implemented method includes: perspectives comprised of one or more web applications; accessing one or more web applications through a dedicated URL; and determining the one or more user identifiers through use of an authentication web application.

In an aspect of the invention, a computer implemented method of authenticating users of a user interface on a display device is provided. The method comprises the steps of (a) appointing a first functional web application for controlling an initial display of information upon the user interface on the user display device, based on user context information associated with a user of the user display device; (b) retrieving a first set of one or more contributions from one or more web applications associated with a user perspective based on the user context information, and displaying the retrieved first set of one or more contributions, and content provided by the first web application, upon the user interface at the user display device; (c) receiving user selections based on the first set of one or more contributions; (d) determining whether the user is authenticated to perform such user selections, and where the user is authenticated progressing to step e), and where the user requires authentication, calling an authentication web application for controlling the subsequent display of authentication information upon the user interface and receiving authentication information and authenticating the user and passing control of the initial display of information to the first functional web application; (e) appointing a second functional web application for controlling a subsequent display of information upon the user interface on the display device, based on the user interaction with the first set of one or more menu contributions; and (f) retrieving a second set of one or more contributions from the one or more web applications associated with the user interaction with the first set of one or more contributions, and displaying the retrieved second set of one or more contributions upon the user interface at the user display device.

The computer implemented method; includes perspectives that are comprised of one or more web applications; wherein the one or more web applications are accessed through a dedicated URL; and determining the one or more user identifiers through use of an authentication web application.

In other aspects, computer programming and other apparatus, systems and methods are provided to achieve the above and other aspects to the invention.

### BRIEF DESCRIPTION OF THE DRAWING FIGURES

For a better understanding of the present invention and to show more clearly how it may be carried into effect, reference will now be made, by way of example, to the accompanying drawings, which show a preferred embodiment of the present invention and in which:

FIG. 1 is a block diagram of the components of an exemplary embodiment of a website generation system;

FIG. 2 is a block diagram of the components of a website of the system of FIG. 1;

FIG. 3 is a block diagram of the interaction of high level components of the system of FIG. 1;

FIG. 4 is a block diagram of components of context information within website generation system of FIG. 1;

FIG. 5 is a block diagram illustrating components of web applications within the system of FIG. 1;

FIG. 6 is a flowchart illustrating a user authentication method within the system;

FIG. 7 is a flowchart illustrating a menu generation method usable with the system of FIG. 1; and

FIG. 8 is a flowchart of a website display and interface generation method usable with the system of FIG. 1.

### DETAILED DESCRIPTION OF THE PREFERRED EMBODIMENT

It will be appreciated that, numerous specific details have provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein.

The embodiments of the apparatus, systems and methods described herein may be implemented in hardware or software, or a combination of both. Furthermore, the system, processes and methods of the described embodiments are capable of being distributed as computer programming in a non-transient computer program product comprising a computer readable medium that bears computer usable instructions for execution on one or more processors.

The description which follows, and the embodiments described therein, are provided for illustration by way of an example, or examples, of particular embodiments of the principles of the present invention. These principles are provided for purposes of explanation, and not limitation of those principles, and of the invention.

The embodiments described herein, as will be more fully understood with the accompanying description, relate to methods and systems for generating, and integration of aspects to, user interfaces for user-facing applications within one or more websites. The term user interface is used herein to refer to interfaces accessible to a user which accept input from a user through one of a variety of input methods mechanisms and generate output, such as web pages that are viewable through a web browser program or other interface application. The term website is used herein to refer to websites that a user will visit which have associated one or more user interfaces.

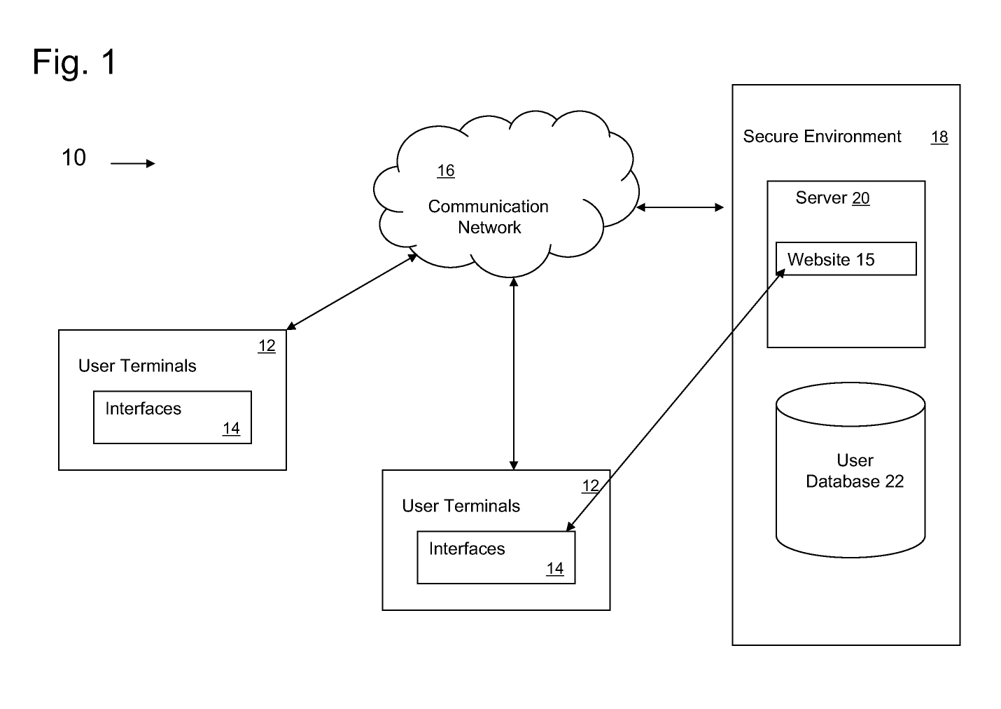

Reference is now made to FIG. 1 where a block diagram illustrating components of a website generation system 10 is shown in an exemplary embodiment. The website generation system 10 is used to generate and integrate various components of user interfaces 14 that are accessible to users through user terminals 12 into one or more websites 15. User terminals 12 include any computing system that may access web browsers and may include but are not limited to desktop computers, laptops, server type computers, hand held computers, wireless device, and mobile phones. The user terminals 12 access a secure environment 18 through a communication network 16. The communication network 16 may be any network including a wired or wireless network, including the Internet or an Intranet.

Through the communication network 16, the user terminals 12 can access the secure environment 18. The secure environment 18 may be any environment in which one or more servers type devices 20 may be stored securely and are used the website 15, and to generate the one or more user interfaces 14 associated with the website 15, as described in more detail below. For purposes of this description, the secure environment 18 will be described in reference to a financial institution. However, it will be understood by one of skill in the art that the secure environment 18 may be described with reference to, and adopted for use with, any entity that provides secure access and/or requires user authentication prior to accessing the secure environment and the offerings associated with the secure environment 18 such as the website 15 and the associated user interfaces 14.

The secure environment 18 in an exemplary embodiment comprises one or more server type devices 20. The server type devices 20, or servers 20, are connected to the communication network 16. The server type device 20 has resident upon it, or associated with it one or more websites 15. Website 15 is described in further detail below. The websites, and the one or more user interfaces 14 associated with each website 15 are generated and integrated through the use of multiple peer web applications, which are described in further detail below. The peer web applications as described below access a user database 22 in the secure environment 18 when required to authenticate users. The user database 22 contains information regarding the various users who access the system 10 including their respective access permissions and associated authentication information. The systems and methods described herein describe systems and methods of integrating various components and/or aspects of user interfaces with regards to one or more websites 15 through the use of multiple peer web applications, which are each used to provide specific functionality and/or content that are then integrated into user interfaces.

A system architecture whereby multiple smaller peer web applications that are functional (such as, relating to providing one or a small subset of functions) and smaller content repositories (such as, relating to providing one type or a small subset of content that may be associated with particular web applications) is used to pass control of a user session back and forth, while also using shared context information, can tend to be advantageous when operating for a large enterprise and/or with many users. For example, if a website is operated by a financial institution for its customers, the use of small peer web applications can tend to permit significantly less resources being used to operate multiple user sessions. Instead of loading an entire instance of a user-requested function of the financial institution (such as, for example, personal computer banking services) which typically includes in the instance a wide variety of functions and content that is not immediately needed or may in fact not be needed by the user in the user session, the use of multiple web applications permit just the functions and content, as encapsulated within subsets of functions and content in particular functional or content web applications, to be loaded and executed by the website server of the financial institution. Thus, there can tend to be memory, storage, and processing cycles efficiencies that are gained by avoiding loading of full instances of services and instead only small web applications.

As one web application executes, it may find that it requires additional functions or content to continue processing, and at such time it may load and execute such other functional web applications or access content repositories, for both presenting content and functions to the user, and/or updating/revising a shared context cache held by the website server that facilitates operation of multiple web applications for a user in a user session. In an embodiment, the web applications can be provided when a user, through an interface application (such as a web browser) accesses a website of the financial institution. A perspective (as described in more detail below) can be generated in conjunction with a shared context cache, which may be used by the website in organizing and providing functionality (and thus, service) to customers of the financial institution. These aspects are described in more detail below.

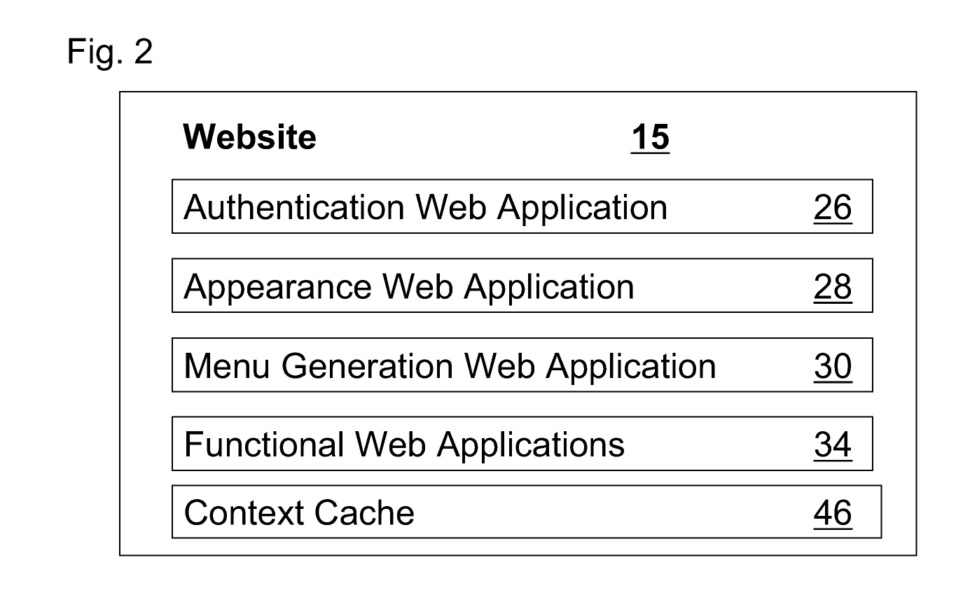

Reference is now made to FIG. 2, where a block diagram illustrating the building block peer web application components of the website 15 are shown in more detail. Each peer web application used in the system 10 has associated with it specific functionality or content that is used for the purposes of providing the user with the content and/or functionality they require based on the user's interaction, when taking into account the user's context information which is described in further detail below. The peer web applications are responsible for the overall display of all content and functionality that are associated with the user interfaces 14 presented to the user. Each website 15 has associated with it multiple user interfaces which are generated based upon the offerings including the functionality and content that are to be presented to each user, and which are further customized based on the user's interaction. The reference to the web applications as being peer web applications is used to illustrate the concept that there is no one web application used in the system 10 that acts or is required to act as a central conduit through which operation of the system 10 is contingent. Rather, as will be described below, depending upon the user context, the user's interaction and the offerings that are to be presented to the user, multiple peer web applications will be responsible for the generation of the user interfaces 14. The web applications are able to call other web applications, or peer with other applications, which in one embodiment provides that one web application is always responsible for the control of the display that is shown to the user at a particular time.

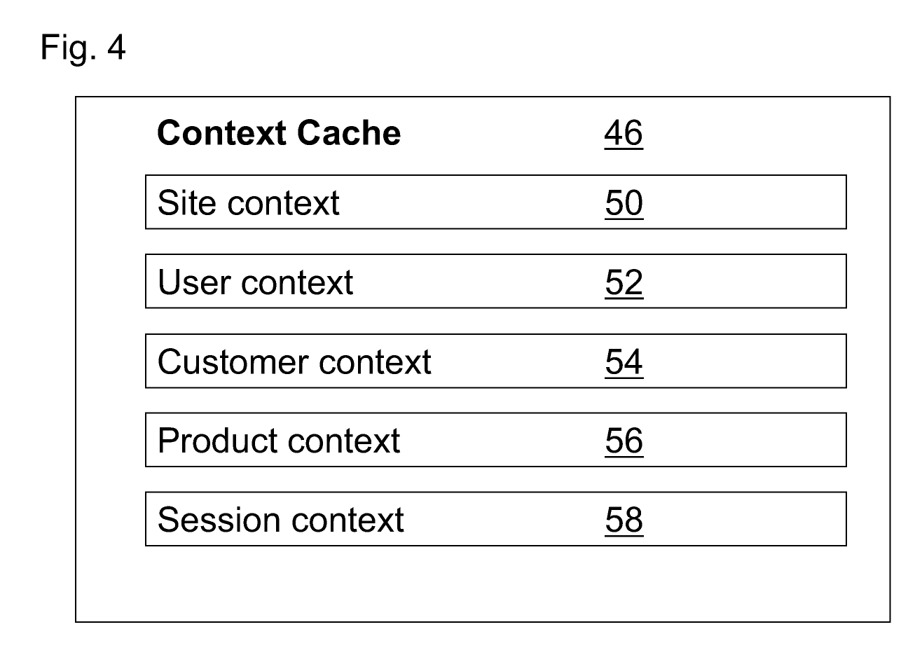

As described below, the determination of which from among the peer web applications is responsible for such control is based on the user's context, the user interaction, and the offerings including content and functionality which are to be provided to the user. The peer web applications or web applications as they will be referred to herein are described with respect to the web applications used to generate the user interfaces 14 as described below. The web applications required for the system 10 in one embodiment include an authentication web application 26, an appearance web application 28, a menu generation web application 30, cache one or more functional web applications 34 and a context cache 46 described in more detail in FIG. 4. The authentication web application 26 is used to authenticates users and is called when required by the one or more functional web applications 34 as described below. The appearance web application is used to share style and display information that are used by the functional web applications 34 that specify the appearance of the user interface 14. In one embodiment, cascading style sheets are shared by the appearance web application 34 among the functional web applications 34 that are in control at a point in time of the respective display or user interface 14 which are used to provide the specific look and formatting associated with the content that is displayed to the user, including the layout, font, font size, colours and other stylistic elements including images. The menu generation web application 30 is used assemble the various menu elements that are associated with each user interface 14 and are described in further detail below. The functional web applications 34 represent one or more web applications which are used to provide specific functionality or content. The use of the functional web applications is dependent upon the context associated with the user, the user's interaction, and the offerings that are to presented to the user with respect to content and functionality. One of the functional web applications 34 or the authentication web application 26 will always be in control of the display or the user interface 14. The based on the user's interaction, another functional web application 34 or the authentication web application 26 (where the user has not been authenticated) may be seamlessly transitioned to. The context cache 46 is used to share information regarding a user within one session across multiple web applications, as explained in further detail below.

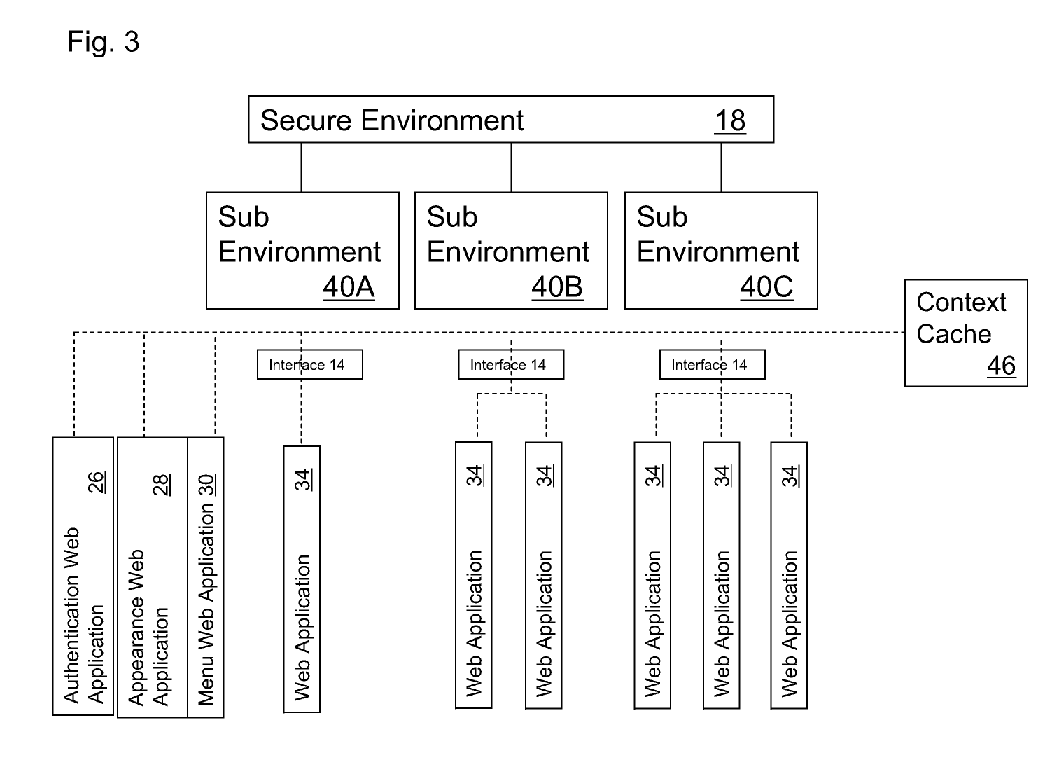

Reference is now made to FIG. 3 where a block diagram illustrating the interaction of the various high level components of the system 10 is shown. A financial institution is used for purposes of this description. For purposes of this example, the website 15 will be described with respect to a financial institution but it will be understood by those of skill in the art that the web site may represent any web site associated with any business or industry. The secure environment 18 has associated with it one or more sub environments 40 shown as sub environments 40A, 40B and 40C in FIG. 3. The sub environments 40A-C represent environments within an organization that provide users with different services and correspondingly with different user interfaces based on varying perspectives. With respect to the example of a financial institution, the various sub environments 40A-C may relate to the type of accounts/services that are offered by a financial institution, which may include personal or commercial accounts for purposes of this example. However, it will be understood that these sub environments are provided only for purposes of example, as a secure environment may have associated with it one or more sub environments.

Three sub environments 40A-C are shown in FIG. 3. Each sub environment has associated with it a user interface 14. The user interface 14 for purposes of this description is used to refer to the interactive and visual elements that are present upon the display shown on the display device. As will be explained in further detail below, the interactive elements represent any functionality that a user can interact with, including any text buttons and text entry fields. The user interface 14 is generated partly based on what is referred to herein as a perspective. The perspective represents an assembly of one or more web applications 34. The perspective represents one of a set of views that is shown to the user based on a combination of the user's context information and default content or menu options that are provided to the user upon the user interface 14. Each perspective represents an assembly of one or more web applications that contribute one or more menu contributions for display upon the user interface 14. Each user interface 14 that can be displayed at a user terminal 12 may be generated by integrating one or more functional web applications 34. In one embodiment, the perspective represents the menu contributions that will be shown to the user depending on user context.

The user context information as described herein is provided or retrieved through the authentication web application 26 and the associated context information. As described above, each of the functional web application 34 or the authentication web applications 26 can be understood to own the display that that is shown to the user and in integrating the various components displayed upon an interface aggregates content from other web applications as described in detail below. The authentication web application 26, the appearance web application 28 and the menu generation web application 30 are called as needed by the one or more functional web applications 34 that are responsible for the user interface 14 associated with each sub environment 40A-C. FIG. 3 is provided for purposes of example, to illustrate the interrelations between the web applications with respect to generating multiple user interfaces 14. As is shown in FIG. 3, the user interface 14 at a point in time associated with sub environment 40A has associated with it one functional web application 34 which is responsible for the control of the display, and which is reliant only upon the authentication web application 26, the appearance web application 28, and the menu web application 30 to as necessary for the display upon the user interface 14. With respect to sub environment 40 B, and the associated user interface 14 at a point in time, two functional web applications 34 are used for purposes of the user interface, where one of those two functional web applications 34 is in control of the display upon the user interface, and the other is providing content or functionality.

The authentication web application, 26, the appearance web application 28, and the menu web application 30 provide functionality that is required by the respective functional web applications 34 that can serve as a functional repository of routines and procedures that are required by the functional web applications 34. The authentication web application 26 allows for common authentication methods and/or routines to be used for authentication of users. The menu web application 30 generates menu elements for the user interface 14 based on the user perspective. The menu web application 28 is used to generate various menu elements that are integrated into the user interface. Menu elements that are generated include menu items, menu markers, and menu placeholders and are described in further detail below. The menu contributions in one embodiment are provided through calling dedicated URLs which provide the required contribution. The web applications are all called through reference in one embodiment to dedicated URLs for such web applications. The appearance web application 28 provides the functionality required to generate page layouts and styling used by the other peer web applications 34 and the images that are used including all logos and icons. The appearance web application 28 also serves as a common repository for common logos, icons and styles, and also for script files that may include but are not limited to javascript files may be stored for subsequent use. For each user session a user has associated with it, context information may be retrieved from a context cache 46 in an exemplary embodiment. The context cache 46 stores information regarding a user, which is retrieved by one or more concurrently running web applications and their session can be stored for further retrieval. Therefore, certain information, including a user's context, may then be shared among the various respective web applications that are used to generate the respective user interfaces. The web applications that comprise the user interface have access to the context cache 46. The context cache acts as a central repository whereby context information for each user, including in some embodiments session data, is stored as illustrated in further detail below.

Reference is now made to FIG. 4 where a block diagram illustrating the components associated with the context cache 46 are shown in an exemplary embodiment. The context information in an exemplary embodiment for each user includes a site identifier 50, a user context 52, a customer context 54, a product context 56 and a session context 58. For purposes of description the contexts that have been described herein have been shown with reference to context information that a financial institution would want to track for purpose of allowing a user the ability to access the secure environment through the establishment of concurrent sessions. However, it will be understood by one of skill in the art that the context information that is stored relates to the environment for which the system 10 is being implemented.

The site context 50 tracks information pertaining to the interface application, or browser application, that was used or is being used to visit the web site associated with the secure environment 18, such as from a user terminal 12. When dealing with unauthenticated users, the site context 50 can be used to track the attempt to access one or more websites 15 in the secure environment. The site context 50 can also store a unique identifier when a web application that is part of the user interface 14 is visited. The site context 50 in one embodiment may be stored in a browser as a unique identifier. The site context 50 is subsequently used to track a user's activity. The user context 52 represents information regarding whether the user has been authenticated. The user identifier indicating that the user has been authenticated is available to other web applications which may require this user authentication information through an API that is associated with such web applications. The customer context 54 represents information regarding a user or customer's identifiers. The product context 56 is used to track the current product that the user may have selected.

The session context 58 is initiated when a web application is used and will expire upon an explicit timeout or logout.

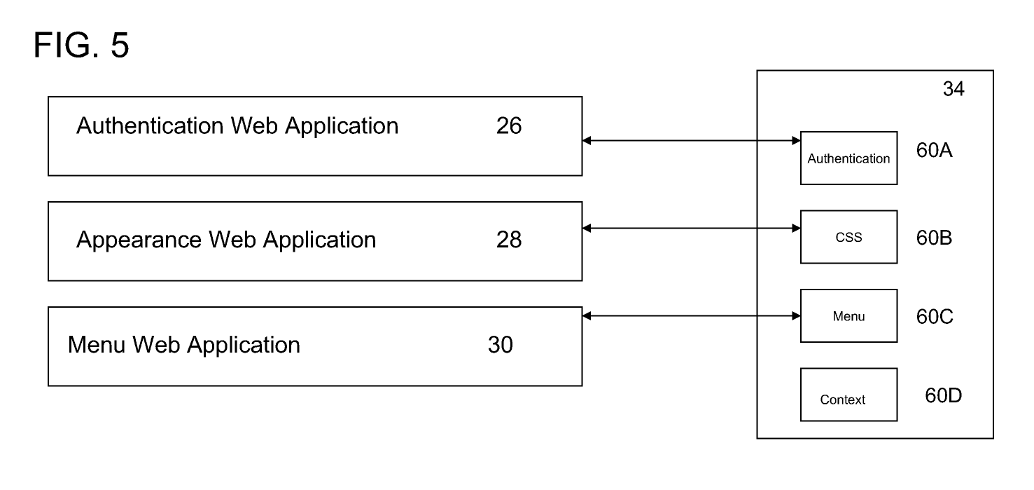

Reference is now made to FIG. 5, where a block diagram illustrating in further detail components described earlier with reference to FIG. 3. FIG. 5 illustrates the functional web applications 34, and their components 60 The components 60 of each web application 34 refer to a shared library of functions that may be incorporated into each web application 34, which is integrated into the user interface 14. Each web application 34 has associated with it one or more components that implement the functionality as found in one of the authentication web applications 26, the appearance web applications 28 and the menu web applications 30. In an exemplary embodiment, the components are a authentication component 60A, a style component 60B, a menu component 60C and a context component 60 D.

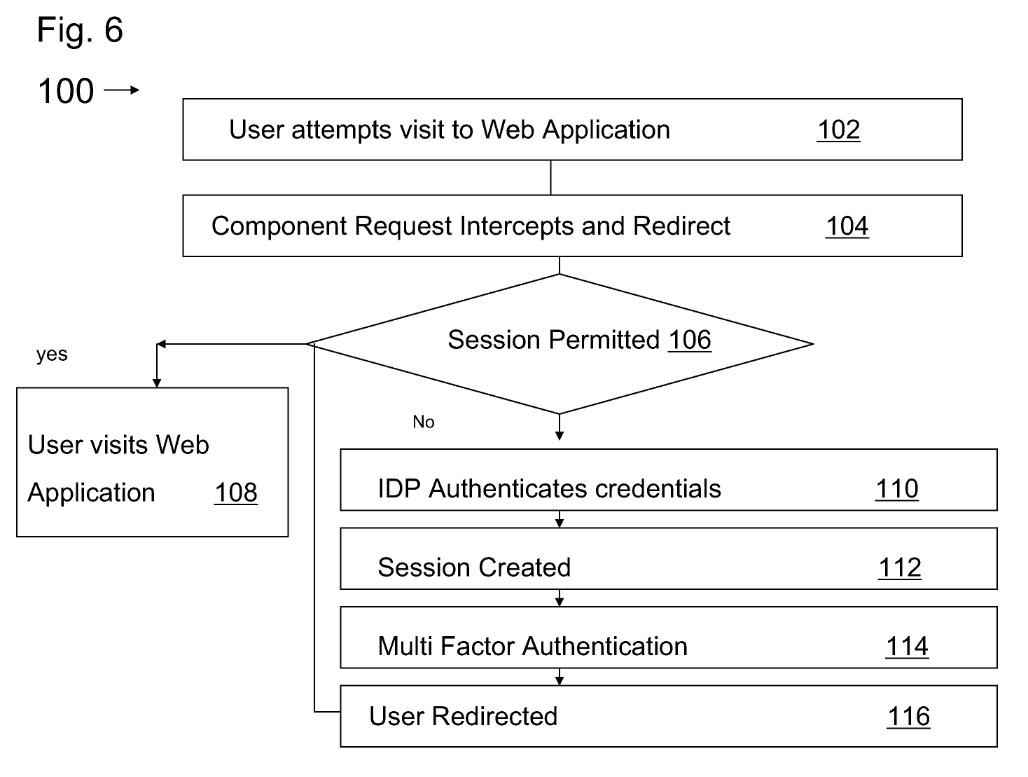

Reference is now made to flowcharts shown in FIGS. 6-8, which illustrate the functionality of the web application and exemplary processes and methodologies associated with the web applications in an exemplary embodiment. Reference is now made to FIG. 6, where a flowchart illustrating the steps of the user interface authentication method 100 is shown in an exemplary embodiment. The authentication method 100 is used herein to illustrate the steps that are carried out by the system 10 when a user is to be authenticated. The authentication method 100 provides for a centralized method of authentication where authentication web application 26 is used. Method 100 is described with respect to a user's interaction with a financial institution website 15, however, It will be understood that some of the steps that are described herein may be specific to a financial institution but may also be customized for other purposes or interactions.

In FIG. 6, an exemplary authentication method 100 begins at step 102, where the user attempts to access a user interface 14 as part of a website 15 associated with the secure environment 18. The interface is comprised of one or more web applications. The authentication component associated with the functional web application that controls the display at step 104 intercepts a user request to access another functional web application 34 and redirects to the authentication web application where required. The routine at step 106 checks to determine whether the session that the user wishes to initiate is permitted. The check is performed based on the analysis of the context data associated with the user, which indicates the user's permissions associated with the requested web application 34. For example, in a financial institution environment, a user may have provided their authentication information when accessing one sub environment, which may not allow them unrestricted access to all sites and services provided through the financial institutions offerings. If the result of the check performed at step 106 indicates that the user is permitted to access the particular requested functional web application 34, the content/functionality of the requested web application is provided at step 108. The user's interaction with the displayed user interface 14 and the functionality displayed thereon translates to one or more requests for specific web applications. From the point of view of the user, the user is not aware that a specific functional web application 34 has been requested, as the user has requested specific content or functionality which is provided by the web application 34 in a manner that is seamless to the user. If the results of the check performed at step 106 indicates that the user is not permitted to access the content/functionality provided by the requested web application, method 100 then proceeds to step 110, where an identity provider process is called based on the authentication web application 26, where the user is asked to provide authentication information. Method 100 then proceeds to step 112, where session information is created. Method 100 then proceeds to 114, where a muti factor authentication process is carried out. The multi factor authentication process compares the authentication information provided with the required authentication information and proceeds to step 116 where the user is redirected back to the content/functionality that the user has requested.

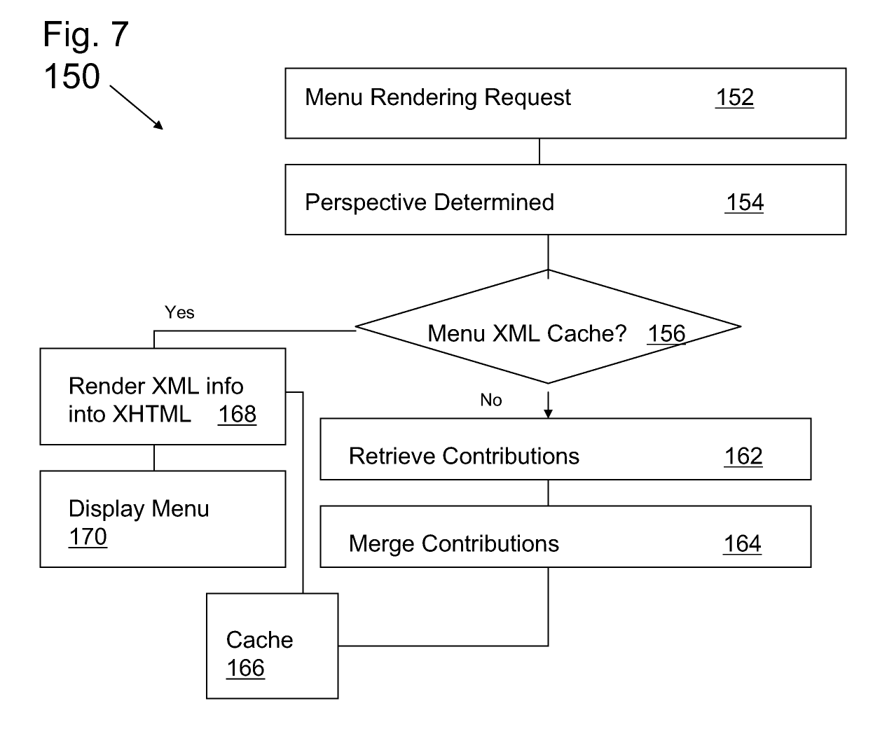

Reference is now made to FIG. 7, where a flowchart illustrating the steps of a menu rendering method 150 is shown in an exemplary embodiment. The menu rendering method 150 can be executed where the menu generation web application 30 is used by one or more of the functional web applications 34 and is used to render and generate menus for the respective functional web application 34. Method 150 begins at step 152, where a menu rendering request is made by the functional web application 34 that is control of the display. Method 150, then proceeds to step 154, where the perspective associated with the user is determined.

Method 150 then proceeds to step 156 where a determination is made as to whether the menu that is required may be retrieved from a menu cache that is associated with the system 10. Where the check performed at step 156 indicates that the menu may be retrieved from the menu cache, a conversion of the XML menu is undertaken at step 168, and the menu is then displayed to the user at step 170. Where the check performed at step 156 indicates that the menu is not present within the menu cache, method 150 proceeds to step 160, where the contributions to the menu that is to be generated are retrieved from contributing web applications, and are merged into the menu at step 164. The menu is then stored into the menu cache at step 166 and steps 168 as described above are carried out.

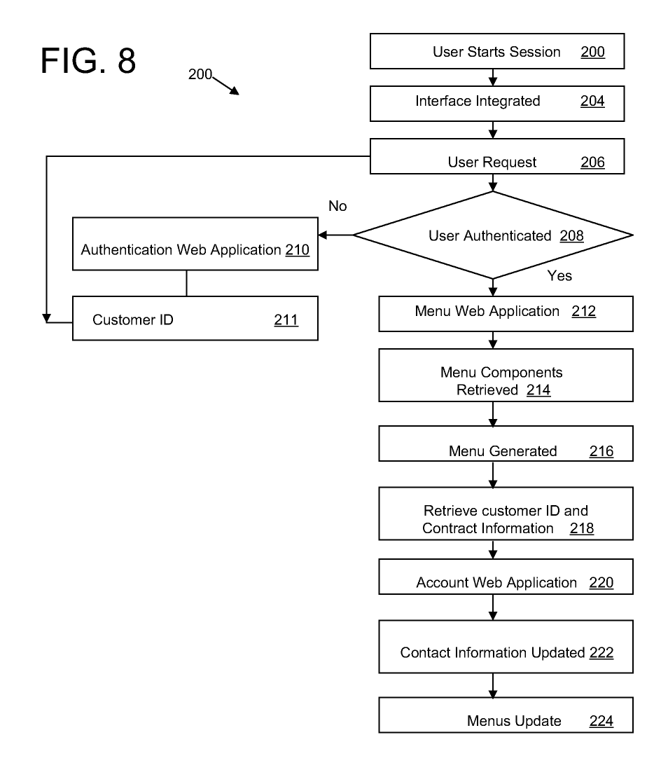

Reference is now made to FIG. 8, where a flowchart illustrating the steps of a display method 200 is shown in an exemplary embodiment. The display method 200 is used to illustrate the functionality of the respective web applications and the context information in generating the interfaces. The description provided herein with respect to FIG. 8 is provided with respect to the example of a financial institution, and it will be understood by one of skill in the art, that the web applications described herein may be used to implement interfaces that provide different functionality then the ones described herein. Method 200 provides to the user a description of the interoperability of the various components associated with the system 10, and is described with reference to the example of a financial institution.

Method 200 begins at step 202, where a user starts a session by accessing a dedicated website 15. Upon accessing the website, a first interface is generated through the use of a functional web application 34 at step 204. The functional web application 34 used for the first interface displays to the user a default interface. The interface provides the user with various features and functionality from which they can further navigate and interact and engage with subsequent offerings associated with the financial institution, based on the user's context as previously described. The interface generated for the user at the first instance is based on the a perspective that has been determined for the user based on the user's context information. Initially, where the user has first accessed the website 15, the perspective may resort to a default perspective. The perspective is retrieved, and as the perspective is comprised of contributions from one or more web applications 34, the various menu contributions from those one or more web applications are assembled and displayed to the user. The one or more contributions associated with each web application 34 are accessed through a dedicated URL, where upon the call being made to the dedicated URL, the respective web application will provide the menu contribution it is responsible for. Method 200 then proceeds to step 206, where the user makes a requests by engaging the interface based on functionality displayed to the user. Where the user makes a request, method 200 then proceeds to step 208, where a determination is made regarding whether the user has proper authentication in order to request the specified functionality. If it is determined at step 208, that the user is not authenticated, method 200 then proceeds to step 210. At step 210, the authentication web application 26 is invoked in order to perform the authentication functions. The authentication web application 26 is invoked and the user is redirected to the authentication application through the user's browser, where the user provides the authentication information that is requested. Where the authentication web application 26 is engaged, the functional web application 34 that was responsible for control of the display, ceases control of the display to the authentication web application 26, which when engaged is in control of the display. Through invoking the authentication web application 26 only when necessary, the process employed when a user engages with the interfaces, is streamlined to call web applications only when required. Method 200 then proceeds to step 210, where the user attempts to authenticate themselves, and upon successful authentication, a customer identifier is generated that is specific to a session and the user is redirected to the original functional web application 34 which was responsible for control of the display prior to the authentication web application having been invoked. Upon the customer identifier being generated, the context information is updated at step 210. Upon the completion of step 210, method 200 returns to step 206, where a user request is made. The user may make any request based on the functionality that is provided to them. For purposes of illustration, the integration example is described with respect to a user requesting a financial summary of their account holdings. Where it is determined at step 206 that the user is authenticated to perform such functions (through the updating of the context information as described at step 210. Where such information is requested, another functional web application 34, that is responsible for such functionality is invoked and will then control the display. The functional web application 34 responsible for displaying content related to the account summary then makes reference to the menu generation web application 30 and the appearance web application 30 at step 212, and at step 214 the menu components that are part of the financial summary interface are retrieved and at step 216 are rendered. At the conclusion of step 216, the user has transitioned from a first interface that was shown to them upon accessing of a website where the user was subsequently required to authenticate themselves to an interface that is displayed that summarizes all of the user's financial holdings through invoking of three web applications. Upon the user engaging with the functionality that is provided to them upon the user interface, a functional web application 34 different than the one that was initially responsible for display of the interface 14 controls the display. The web applications that are part of this system are able to seamlessly call other web applications based on the user's interaction to ensure that one web application 34 is always in control of the display. The web applications are able to provide the functionality and content to the user by making calls to the required web applications based on the user's perspective and/or the user's input and context information. Method 200 then proceeds to step 218, where context information is retrieved to determine what offerings the user has access to. This context information that is retrieved is then used to determine which offerings should be displayed to the user upon the interface. Method 200 then proceeds to step 220 where the account web application is used to generate the interface displayed to the user through information obtained at step 218 with respect to the offerings that should be provided to the user.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A computer-implemented method for generating a user interface customized for a user, the method comprising the steps of:
(a) retrieving one or more user identifiers associated with the user;
(b) selecting a predetermined user perspective based on the one or more user identifiers;
(c) sending a request to the one or more web applications associated with the user perspective, each web application receiving the request responding with one or more menu contributions that are determined based on the one or more user identifiers; and
(d) displaying the one or more menu contributions received from the one or more web applications upon the user interface.

2. The computer-implemented method of claim 1, wherein the one or more user identifiers include information regarding one or more offerings that are available to the user.

3. The computer-implemented method of claim 1, wherein the perspective is comprised of one or more web applications.

4. The computer-implemented method of claim 3, wherein the one or more web applications are accessed through a dedicated URL.

5. The computer-implemented method of claim 1, further comprising determining the one or more user identifiers through use of an authentication web application.

6. The computer-implemented method of claim 5, wherein the one or more user identifiers are stored in a centralized cache for retrieval by the one or more web applications for use in generating the customized user interface.

7. A computer-implemented method of generating on a display device a user interface customized for a user, the user having associated context information, the method comprising the steps of;
(a) selecting a first web application to control the display upon the user interface based on the context information, the first web application accessing a second web application and a third web application;
(b) retrieving one or more style components from the second web application based on the user's context information;
(c) retrieving one or more menu components from the third web application based on the user's context information;
(d) displaying the one or more style components and one or more menu components upon the user interface on the display device.

8. The computer-implemented method of claim 7, wherein the one or more menu components are retrieved based on a perspective associated with the user.

9. The computer-implemented method of claim 8, wherein the perspective is determined based on the context information.

10. The computer-implemented method of claim 7, further comprising the step of displaying content upon the user interface through one or more additional functional web applications, each functional web application having associated with it content.

11. The computer-implemented method of claim 10, wherein the one or more functional web applications are determined based on the context information.

12. The computer-implemented method of claim 8, further comprising the step of determining the user's interaction with the one or more menu components.

13. A computer-implemented method of integrating the components of one or more web applications into a user interface being generated at a user display device, the method comprising the steps of:
(a) determining a first web application for controlling the display of information upon the user interface on the user display device based on user context information associated with a user of the user display device;
(b) determining a user perspective associated with the user accessing the user interface;
(c) selecting the one or more web applications as those associated with the user perspective;
(d) retrieving one or more contributions from the one or more web applications associated with the user perspective based on the user context information; and
(e) displaying the retrieved one or more contributions, and content provided by the dedicated first web application, upon the user interface at the user display device.

14. The computer-implemented method of claim 13, wherein the user perspective is determined based on user context information.

15. The computer-implemented method of claim 14, further comprising the step of retrieving one or more style components from a dedicated style web application.

16. The computer-implemented method of claim 15, wherein the one or more style components are determined based on the user context information.

17. The computer-implemented method of claim 13, wherein the web applications are accessed through dedicated URLs.

18. The computer-implemented method of claim 15, wherein the user context information is determined based on an authentication web application.

19. The computer-implemented method of claim 18, wherein the user context information is stored in a centralized cache.

20. A computer-implemented method of controlling the display of a user interface on a display device, comprising the steps of:
(a) appointing a first web application for controlling an initial display of information upon the user interface on the user display device, based on user context information associated with a user of the user display device;
(b) retrieving a first set of one or more contributions from one or more web applications associated with a user perspective based on the user context information, and displaying the retrieved first set of one or more contributions, and content provided by the first web application, upon the user interface at the user display device;
(c) receiving user input based on user interaction with the first set of one or more contributions;
(d) appointing a second a web application for controlling a subsequent display of information upon the user interface on the display device, based on the user interaction with the first set of one or more menu contributions; and
(e) retrieving a second set of one or more contributions from the one or more web applications associated with the user interaction with the first set of one or more contributions, and displaying the retrieved second set of one or more contributions upon the user interface at the user display device.

21. The computer-implemented method of claim 20, wherein the perspective is comprised of one or more web applications.

22. The computer-implemented method of claim 21, wherein the one or more web applications are accessed through a dedicated URL.

23. The computer-implemented method of claim 22, further comprising determining the one or more user identifiers through use of an authentication web application.

24. The method of claim 20 comprising the steps of repeating steps (d) to (e) in response to receiving user input based on user interaction with one or more menu contributions.

25. A computer-implemented method of authenticating users of a user interface on a display device, comprising the steps of:
(a) appointing a first functional web application for controlling an initial display of information upon the user interface on the user display device, based on user context information associated with a user of the user display device;
(b) retrieving a first set of one or more contributions from one or more web applications associated with a user perspective based on the user context information, and displaying the retrieved first set of one or more contributions, and content provided by the first web application, upon the user interface at the user display device;
(c) receiving user selections based on the first set of one or more contributions;
(d) determining whether the user is authenticated to perform such user selections, and where the user requires authentication, calling an authentication web application for controlling the subsequent display of authentication information upon the user interface and receiving authentication information and authenticating the user and passing control of the initial display of information to the first functional web application;
(e) appointing a second functional web application for controlling a subsequent display of information upon the user interface on the display device, based on the user interaction with the first set of one or more menu contributions; and
(f) retrieving a second set of one or more contributions from the one or more web applications associated with the user interaction with the first set of one or more contributions, and displaying the retrieved second set of one or more contributions upon the user interface at the user display device.

26. The computer-implemented method of claim 25, wherein the perspective is comprised of one or more web applications.

27. The computer-implemented method of claim 26, wherein the one or more web applications are accessed through a dedicated URL.

28. The computer-implemented method of claim 27, further comprising determining one or more user identifiers through use of an authentication web application.

29. A system comprising a plurality of network elements for generating a user interface customized for a user, the system comprising:
(a) an authentication network element used to authenticate one or more users and determine user context information associated with each of the one or more users.
(b) a display network element used to provide one or more style elements for the user interface;
(c) a functional network element for use in generating the user interface based on the information provided by the authentication network element and the display network element; and
(d) a context network user element used to store the user context information provided by the one or more users to the to the authentication network element.

30. The system of claim 29, wherein the user interface is generated based on a user perspective.

31. The system of claim 26, wherein the perspective is comprised of one or more network web applications.

32. The system of claim 29, wherein the one or more user identifiers include information regarding one or more offerings that are available to the user.

33. The system of claim 31, wherein the one or more network web applications are accessed through a dedicated URL.

34. A system for integrating the components of one or more web applications into a user interface being generated at a user display device, the system comprising:
(a) a memory for storing user context information; and
(b) a processor coupled to the memory for:
(i) selecting a first web application for controlling the display of information upon the user interface on the user display device based on user context information associated with a user of the user display device;
(ii) determining a user perspective associated with the user accessing the user interface;
(iii) selecting the one or more web applications as those associated with the user perspective;
(iv) retrieving one or more contributions from the one or more web applications associated with the user perspective based on the user context information; and
(v) displaying the retrieved one or more contributions, and content provided by the dedicated first web application, upon the user interface at the user display device.

35. The system of claim 34, wherein the user perspective is determined based on user context information.

36. The system of claim 35, further comprising the step of retrieving one or more style components from a dedicated style web application.

37. The system of claim 36, wherein the one or more style components are determined based on the user context information.

38. The system of claim 34, wherein the web applications are accessed through dedicated URLs.

39. The system of claim 36, wherein the user context information is determined based on an authentication web application.

40. The system of claim 39, wherein the user context information is stored in a centralized cache.

41. A computer-readable medium upon which a plurality of instructions are stored, the instructions when executed by a computer system having a processor and memory, causes the processor to:
load into the memory and process user context information associated with a user of a remote user display device having a user interface thereon;
selecting a first web application for controlling the display of information upon the user interface on the user display device based on the user context information;
determining a user perspective associated with the user accessing the user interface;
selecting one or more web applications as those associated with the user perspective;
retrieving one or more contributions from the one or more web applications associated with the user perspective based on the user context information; and
displaying the retrieved one or more contributions, and content provided by the dedicated first web application, upon the user interface at the user display device.

42. A system for delivering services from a website to an interface application operating on a user device, comprising:
a website server hosting the website configured to accept input from the user device and a request from a user through the interface application operating on the user device associated with accessing a perspective of the website, the service having available a set of content and functions that it can provide from the website to the user device;
a plurality of content repositories each for providing a subset of content of the set of content and functions of the perspective;
a plurality of functional web applications each for providing a subset of functions of the set of content and functions of the perspective,
wherein upon the website receiving the request for the service, one of the plurality of functional web applications is loaded and executed by the website server, the one functional application:
accessing a content cache on the website server associated with the user and, if it is determined by the one functional application that the context cache does not meet with requirements for providing the perspective requested, then the one functional application causing the website server to load and execute at least one of another of the plurality of functional web applications and load one of the plurality of content repositories, to interact with the user through the interface application and update the context cache with required context information; and
determining if the interface application is displaying desired information and content to the user in respect of the service, and if not, causing the website server to load at least one of the plurality of content repositories to provide to the interface application the subset of the set of content of the website of the at least one of the plurality of content repositories,
and the one of the plurality of functional web applications, the at least one of another of the plurality of functional web applications and one of the plurality of content repositories, and the at least one of the plurality of content repositories providing subsets of functions and content that together is less than the set of content and functions of the perspective.

43. The system of claim 42, wherein the website server is configured to accept a second request of the user through the interface application associated with accessing a second perspective of the website and providing such to the use device, the second perspective having as requirements for providing the second service the required context information, whereupon receiving the second request the website server loads and executes a second functional web application to provide the second service to the user device, the second functional web application avoiding causing the website server to load and execute the at least one of another of the plurality of functional web applications and load the one of the plurality of content repositories, for interacting with the user through the interface application and updating the context cache with the required context information, and instead accessing the content cache for the required context information.

44. The system of claim 43, wherein each of the loaded and executed functional web applications and content web applications are accessed through a respective dedicated URL.

45. The system of claim 44, wherein the at least one of another of the plurality of functional web applications that the one functional application causes the website server to load and execute if it is determined by the one functional application that the context cache does not meet with requirements for providing the perspective requested is a user authentication web application, and the required context information comprises information associated with the user's authentication status.

46. The system of claim 45, wherein the subset of the set of content of the website of the at least one of the plurality of content repositories provided by the at least one of the plurality of content repositories that the one functional application causes the website server to load and execute comprises content associated with menu components for display at the interface application at the user device.

47. The system of claim 46, wherein the subset of the set of content of the website of the at least one of the plurality of content repositories provided by the at least one of the plurality of content repositories that the one functional application causes the website server to load and execute further comprises style component for display at the interface application at the user device.

48. The system of claim 47, wherein the website is operated by a financial institution and the user is a customer of the financial institution, and the one functional web application is associated with one or more offerings the financial institution makes available to the user.

49. The system of claim 48, wherein the context cache includes information regarding the user held by the financial institution.
